(19) United States
(12) Patent Application Publication
(10) Pub. No.: US 2009/0055311 A1
(43) Pub. Date: Feb. 26, 2009

(54) METHODS FOR IMPLEMENTING SALES TRANSACTIONS USING PREPAID SALES CERTIFICATES HAVING INCREASED VALUE AFTER A PERIOD OF TIME

(76) Inventor: Zdenek ZOBAL, Schenectady, NY (US)

Correspondence Address: HESLIN ROTHENBERG FARLEY & MESITI PC, 5 COLUMBIA CIRCLE, ALBANY, NY, 12203, US

(21) Appl. No.: 12/194,219

(22) Filed: Aug. 19, 2008

Related U.S. Application Data
(60) Provisional application No. 60/957,278, filed on Aug. 22, 2007.

(51) Int. Cl. G06Q 30/00

(52) U.S. Cl. 705/39

(57) ABSTRACT

A method for implementing a sales transaction includes receiving a first payment, issuing a prepaid sales certificate having indicia indicating a first redeemable value for the certificate corresponding to the first payment, and having indicia indicating at a later time a second redeemable value greater than the first payment. The prepaid sales certificate may be received by a merchant, and a determination made whether the later time has passed. Based on the determination whether the later time has passed, at least one of goods and/or services may be provided in exchange for the prepaid sales certificate based on the first redeemable value or the second redeemable value.

### CLAIM TO PRIORITY

This application claims the benefit of U.S. Provisional Application No. 60/957,278, filed Aug. 22, 2007, entitled “Methods for Implementing Sales Transactions Using Prepaid Sales Certificates Having Increased Value After a Prior of Time,” the entire subject matter of which is hereby incorporated herein by reference.

### FIELD OF THE INVENTION

This invention relates generally to sales transactions, and more specifically, prepaid sales certificates having an increased value after a period of time.

### BACKGROUND OF THE INVENTION

Conventionally, purchasing of goods typically involves a customer selecting an item for sale, a price being indicated on the product or a price being agreed upon between merchant and customer, the agreed price being paid or promised to be paid later, e.g., on credit, and the item being taken into the customer's possession.

Merchants often offer gift certificates or gift cards. A customer typically purchases the gift certificate or gift card for a specific amount. The gift certificate or gift card is typicaly given as a gift and redemed for the specific amount by the receiver of the gift certificate or gift card at the merchant.

There is a need for further means for transacting sales of goods and services.

### SUMMARY OF THE INVENTION

In a first aspect, the present invention provides a method for use in implementing a sales transaction between a merchant and at least one of a customer and a recipient. The method includes providing a first payment to the merchant for a prepaid sales certificate having a first redeemable value corresponding to the first payment and at a later time a second redeemable value greater than the first payment, receiving a first payment from the customer, and providing to the customer the prepaid sales certificate indicating the first redeemable value corresponding to the first payment and indicating at the later time the second redeemable value greater than the first payment.

In a second aspect, the present invention provides a method for implementing a sales transaction between a merchant and at least one of a customer and a recipient. The method includes providing a first payment to the merchant for a prepaid sales certificate indicating a first redeemable value corresponding to the first payment and at a later time a second redeemable value greater than the first payment, receiving a first payment from the customer, providing to the customer the prepaid sales certificate indicating the first redeemable value corresponding to the first payment and indicating at the later time the second redeemable value greater than the first payment, providing the prepaid sales certificate to the merchant from the at least one of the customer and the recipient of the prepaid sales certificate, receiving the prepaid sales certificate from the at least one of the customer and the recipient of the prepaid sales certificate, determining whether the later time has passed, and providing at least one of goods and services to the at least one of the customer and the recipient in exchange for the prepaid sales certificate based on whether the later time has passed.

In a third aspect, the present invention provides a method for implementing a sales transaction between a merchant and at least one of a customer and a recipient. The method includes providing a first payment to the merchant for a prepaid sales certificate having a first redeemable value corresponding to the first payment and at a later time a second redeemable value greater than the first payment, receiving a first payment from the customer, providing to the customer the prepaid sales certificate indicating the first redeemable value corresponding to the first payment and indicating at the later time the second redeemable value greater than the first payment, providing the prepaid sales certificate to the merchant from the at least one of the customer and the recipient of the prepaid sales certificate, receiving the prepaid sales certificate from the at least one of the customer and the recipient of the prepaid sales certificate, determining whether the later time has passed, and providing at least one of goods and services to the at least one of the customer and the recipient in exchange for the prepaid sales certificate based on the second redeemable value.

### BRIEF DESCRIPTION OF THE DRAWINGS

The subject matter which is regarded as the invention is particularly pointed out and distinctly claimed in the concluding portion of the specification. The invention, however, may best be understood by reference to the following detailed description of various embodiments and the accompanying drawings in which:

FIG. 1 is a view of a front side first embodiment of a prepaid sales certificate in accordance with the present invention;

FIG. 2 is a view of a front side of an alternative embodiment of a prepaid sales certificate in accordance with the present invention;

FIG. 3 is a view of a rear side of the prepaid sales certificate of FIG. 2;

FIG. 4 is one embodiment of a flowchart or a method in accordance with the present invention for implementing a sales transaction employing the prepaid sales certificates of FIGS. 1-3; and

FIG. 5 is another embodiment of a flowchart or a method in accordance with the present invention for implementing a sales transaction employing the prepaid sales certificates of FIGS. 1-3.

### DETAILED DESCRIPTION OF THE INVENTION

The present invention relates generally to prepaid sales certificates having an increased value after a period of time which may be use as a promise of secured (guaranteed) purchase by customers or purchasers, their agent, or a recipient who may use the certificate.

A merchant may issue a prepaid sales certificate to a customer where an item of sale will not be listed but instead a paid amount, which may be in dollars, is listed. The customer pays the merchant in advance before an item of sale is disclosed or chosen by the customer, their agent, or a recipient who may use the certificate. In one aspect of the present invention, a value of the certificate will increase to a new amount if the certificate is redeemed after a later date, or a period of time. This later date of presentation for an increased value will be listed on the certificate. The certificate of the present invention may be purchased by a customer and used by the customer, their agent, or given to a recipient who may use the certificate.

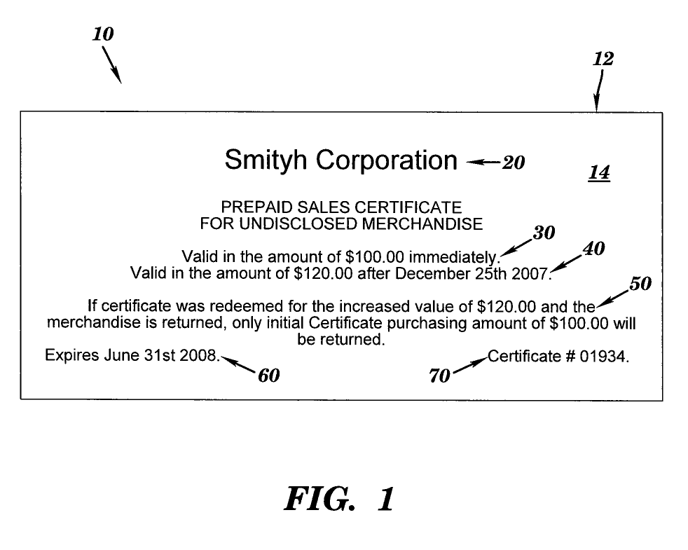

FIG. 1 illustrates one embodiment of a prepaid sales certificate 10 in accordance with the present invention. Exemplary prepaid sales certificate 10 may be fabricated from a planar material 12 such as paper, plastic, or other suitable material having a first or front side 14 and a second or rear side (not shown in FIG. 1). Prepaid sales certificate 10 may include various indicia or information such as a name 20 of a merchant, a first immediate or current predetermined value amount 30 of the certificate, a second predetermined value amount 40 of the certificate after a period of time or a specific date, a value amount 50 for return of merchandise purchased using prepaid sales certificate 10, an expiration date 60, and a certificate number 70. The various information or indicia may be printed on the certificate. It will be appreciate from the present description that some of the information may be printed on the back of the certificate. Additional information may also be provided. For example, further information may include a bar code.

As shown in FIG. 1, a certificate purchased for $100.00, for example, on sale since October 1st will be honored for $100.00 immediately after purchase. The same certificate will have an increase in value and be honored by the merchant, for example, for $120.00 if redeemed after a later predetermined date, for example, after December 25th. It will be appreciated that the increase value may be $5 or 10, or any additional amount.

The merchant may decide when to put the certificate on sale and when an increased value of the certificate will be in effect. For example, the certificate may be valid for use from October 1st, and an increased value of the certificate may be in effect after December 25th. The merchant may also determine an expiration day for the certificate and list it on the certificate as well. The merchant may specify that the certificate can be exchanged for merchandise only, not redeemed for cash. The merchant may determine, that if the certificate is redeemed for the higher later value and the merchandise is later returned to the merchant, only the initial lower value of the certificate will be honored.

An advantage of the prepaid sales certificate of the present invention for the merchant includes the merchant having the customer return to the store. The customer may only purchase merchandise in a particular store using the certificate. The merchant may also likely attract more customers by promising an increased value of the certificate at a later date and possibly obtain a larger share of the market. The merchant may use the buyer's money before the customer uses the certificate to purchase merchandise.

An advantage of the prepaid sales of the present invention for the customer include increased purchasing power if the customer waits to possess merchandise after a predetermined later date. For example, a customer may buy the certificate in October for $100.00 and wait to redeem after December 25th when the value of certificate will be $120.00. The customer may make the final choice of merchandise, for example, the purchase a black coat or blue coat.

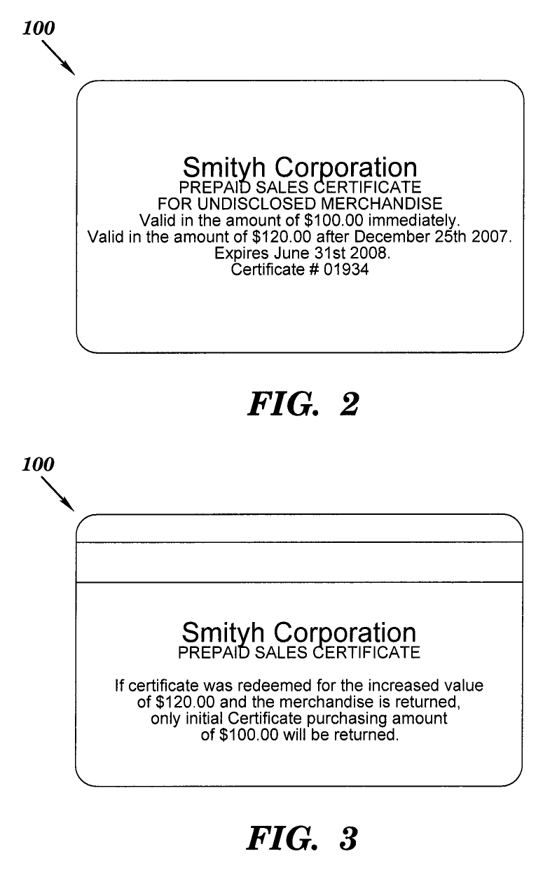

FIGS. 2 and 3 illustrate another embodiment of a prepaid sales certificate 100 in accordance with the present invention. Exemplary prepaid sales certificate 100 is similar to prepaid sales certificate 10 and may be configured on a paper, plastic or other suitable material and include a magnetic strip which may contain various data.

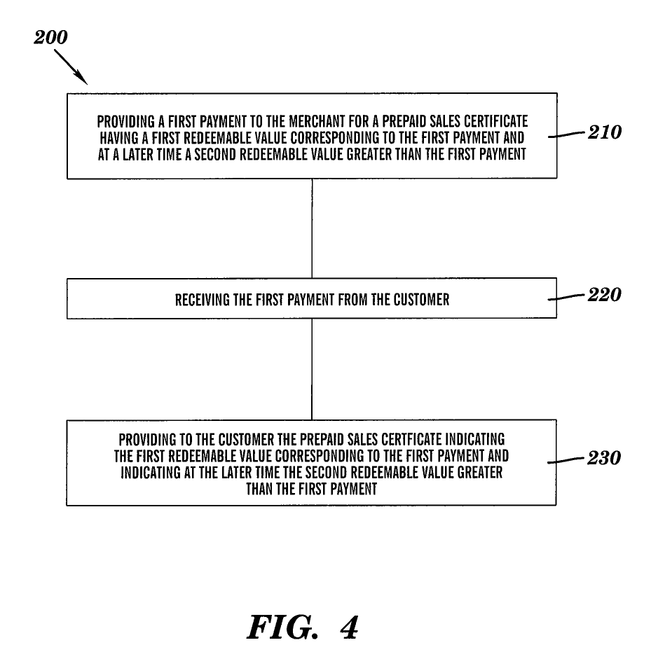

FIG. 4 illustrates an exemplary flowchart 200 employing the prepaid sales certificate. Initially, at 210, a first payment is offered to the merchant for a prepaid sales certificate having a first redeemable value corresponding to the first payment and at a later time a second redeemable value greater than the first payment. At 220, the merchant receives the first payment from the customer, and at 230, the customer is issued the prepaid sales certificate indicating the first redeemable value corresponding to the first payment and indicating at the later time the second redeemable value greater than the first payment

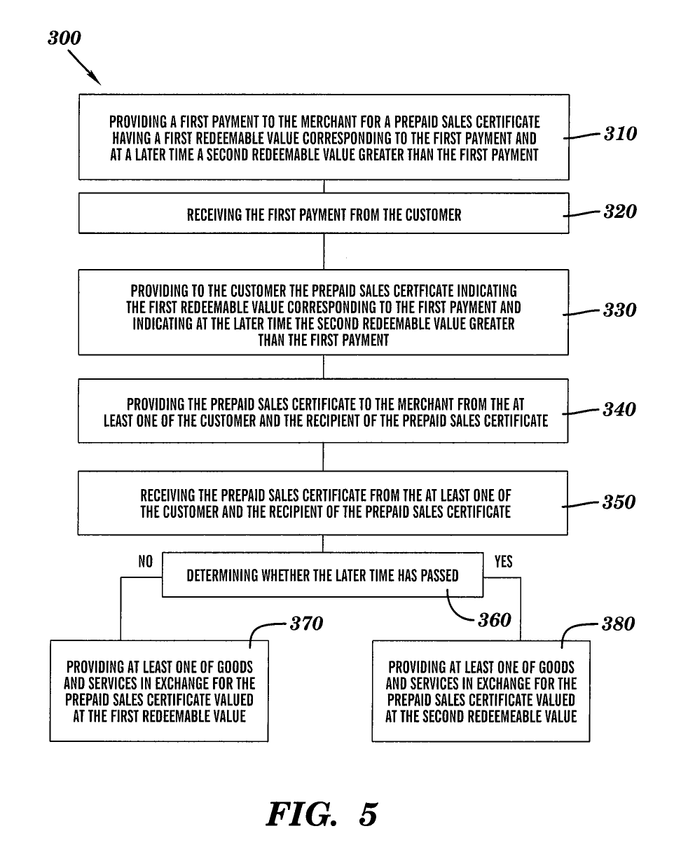

Referring now to FIG. 5, another exemplary flowchart 300 employing the prepaid sales certificate is illustrated. Initially, at 310, a customer offers or provides a first payment to the merchant for a prepaid sales certificate having a first redeemable value corresponding to the first payment and at a later time a second redeemable value greater than the first payment. The merchant receives the first payment from the customer, at 320, such as cash or a credit from the customer, and at 330, provides or issues to the customer the prepaid sales certificate indicating the first redeemable value corresponding to the first payment and indicating at the later time the second redeemable value greater than the first payment. At a later time or future date, the customer or a recipient of the prepaid sales certificate may return to the store or merchant and present the prepaid sales certificate to the merchant, at 340, and the merchant may receive the prepaid sales certificate from the customer and the recipient of the prepaid sales certificate at 350. The merchant determines whether the later time has passed at 360. If the later time has not past, at 370, the merchant provides at least one of goods and/or services in exchange for the prepaid sales certificate based on the first redeemable value. If the later time has passed, at 380, the merchant provides at least one of goods and/or services in exchange for the prepaid sales certificate valued at the second redeemable value. Where the goods and/or services selected by the customer do not total the full amount of the redeemable value, cash or a credit may be provided to the customer. For example, the cash or credit may be the original value (e.g., $100) or the increased value (e.g., $120) as per the discretion of the merchant.

The prepaid sales certificate may be offered in connection with goods, as well as services by merchants such as retail vendors, restaurants, department stores, boutiques, on-line stores, etc.

For example, in another embodiment, indicia may be provided on the certificate for entering the customer's name and entering a recipient's name, such as “To: ______” and “From: ______.” In addition, the prepaid sales certificate may be in the form of a foldable card. While the prepaid sales certificate may have indicia indicating the first redeemable value and indicia indicating the second redeemable value, it will be appreciated that the merchant may write in the first redeemable value and the second redeemable value.

While various embodiments of the present invention have been illustrated and described, it will be appreciated to those skilled in the art that many changes and modifications may be made thereunto without departing from the spirit and scope of the invention.

1. A method for use in implementing a sales transaction between a merchant and at least one of a customer and a recipient, the method comprising:
providing a first payment to the merchant for a prepaid sales certificate having a first redeemable value corresponding to the first payment and at a later time a second redeemable value greater than the first payment;
receiving a first payment from the customer; and
issuing to the customer the prepaid sales certificate having indicia indicating the first redeemable value corresponding to the first payment and indicia indicating at the later time the second redeemable value greater than the first payment.

2. The method of claim 1 wherein the later time comprises a future date.

3. The method of claim 2 wherein the future date comprises December 25th.

4. The method of claim 1 wherein the prepaid sales certificate comprises indicia indicating an expiration date.

5. The method of claim 1 wherein the prepaid sales certificate comprises indicia indicating a merchant for redeeming the prepaid sales certificate.

6. The method of claim 1 wherein the prepaid sales certificate comprises a magnetic strip.

7. A method for implementing a sales transaction between a merchant and at least one of a customer and a recipient, the method comprising:
providing a first payment to the merchant for a prepaid sales certificate indicating a first redeemable value corresponding to the first payment and indicating at a later time a second redeemable value greater than the first payment;
receiving a first payment from the customer;
providing to the customer the prepaid sales certificate indicating the first redeemable value corresponding to the first payment and indicating at the later time the second redeemable value greater than the first payment;
providing the prepaid sales certificate to the merchant from the at least one of the customer and the recipient of the prepaid sales certificate;
receiving the prepaid sales certificate from the at least one of the customer and the recipient of the prepaid sales certificate;
determining whether the later time has passed; and
providing at least one of goods and services to the at least one of the customer and the recipient in exchange for the prepaid sales certificate based on whether the later time has passed.

8. The method of claim 7 wherein the providing the at least one of goods and services comprises providing at the later time at least one of goods and services having a value corresponding to the second redeemable value greater than the first payment.

9. The method of claim 8 further comprising returning the goods to the merchant and providing the first payment to the at least one of the customer and the recipient.

10. The method of claim 7 wherein the providing the at least one of goods and services comprises providing prior to the later time at least one of goods and services having a value corresponding to the first redeemable value.

11. The method of claim 7 wherein the later time comprises a future date.

12. The method of claim 11 wherein the future date comprises December 25th.

13. The method of claim 7 wherein the prepaid sales certificate comprises an expiration date.

14. The method of claim 7 wherein the prepaid sales certificate comprises a merchant for redeeming the prepaid sales certificate.

15. The method of claim 7 wherein the prepaid sales certificate comprises a magnetic strip.

16. A method for implementing a sales transaction between a merchant and at least one of a customer and a recipient, the method comprising:
providing a first payment to the merchant for a prepaid sales certificate having a first redeemable value corresponding to the first payment and at a future date a second redeemable value greater than the first payment;
receiving a first payment from the customer;
providing to the customer the prepaid sales certificate indicating the first redeemable value corresponding to the first payment and indicating at the future date the second redeemable value greater than the first payment;
providing the prepaid sales certificate to the merchant from the at least one of the customer and the recipient of the prepaid sales certificate receiving the prepaid sales certificate from the at least one of the customer and the recipient of the prepaid sales certificate;
determining that the future date has arrived; and
providing at least one of goods and services to the at least one of the customer and the recipient corresponding to the second redeemable value.

17. The method of claim 16 further comprising returning the goods to the merchant and providing payment corresponding to the first payment to the at least one of the customer and the recipient.

18. The method of claim 16 wherein the future date comprises December 25th.

19. The method of claim 12 wherein the prepaid sales certificate comprises an expiration date.

20. The method of claim 12 wherein the prepaid sales certificate comprises a merchant for redeeming the prepaid sales certificate.

21. The method of claim 12 wherein the prepaid sales certificate comprises a magnetic strip.
